(19) United States
(12) Patent Application Publication
(10) Pub. No.: US 2026/0166467 A1
(43) Pub. Date: Jun. 18, 2026

(54) Drying air generator

(71) Applicant: Motan Holding GmbH, Konstanz (DE)

(72) Inventor: Hanson WANG, Jiangsu Province (CN)

(73) Assignee: Motan Holding GmbH, Konstanz (DE)

(21) Appl. No.: 19/124,355

(22) PCT Filed: Oct. 26, 2023
(86) PCT No.: PCT/EP2023/000056

§ 371 Date: Apr. 25, 2025

(30) Foreign Application Priority Data
Oct. 28, 2022 (CN) 2022228688510

(51) Int. Cl. B01D 53/04; B01D 53/26; D06F 58/20; D06F 58/24

(52) U.S. Cl. CPC B01D 53/0438; B01D 53/261; D06F 58/206; D06F 58/24

(57) ABSTRACT

A single fan double tower parallel drying air generating device includes a dehumidification tower group. One end of the dehumidification tower group is connected with an air outlet control valve, the other end is connected with a regeneration heater. The other section of the regeneration heater is connected with a water cooler. The other end of the water cooler is connected with a fan. The other end of the fan is connected with a return air filter. A return air control valve is set between the fan and the return air filter. A bypass air duct is set between the dehumidification tower group and the air outlet control valve. The bypass air duct is connected to the regeneration control valve group. The other end of the regeneration control valve group is connected to the return air control valve through a duct.

### CROSS-REFERENCE TO RELATED APPLICATION

This application is a national stage application, filed under 35 U.S.C. § 371, of International Patent Application PCT/EP2023/000056, filed on Oct. 26, 2023, which claims the benefit of Chinese Patent Application CN 2022228688510, filed on Oct. 28, 2022.

### TECHNICAL FIELD

The invention belongs to the technical field of dryers, in particular to a drying air generator.

### BACKGROUND

In the production process of plastic products, low dew point air is usually required to dry engineering plastic materials with strong hygroscopicity. The traditional dehumidification dryer needs to heat the air to regenerate the adsorbent in the process of manufacturing low dew point air, so that the adsorbent can reabsorb water. In the working process of traditional dehumidification dryer, there are often multiple dehumidification towers. Take the double tower dehumidification dryer as an example. When the adsorbent in one dehumidification tower works, the adsorbent in the other dehumidification tower will enter the regeneration process. The regeneration process is divided into two steps: heating and cooling. After the adsorbent in one dehumidification tower is regenerated, it will enter the standby state. After the other dehumidification tower enters the regeneration, the one dehumidification tower will start to work, and so on.

In this process, the drying fan provides the drying air required for work and the regeneration fan provides the hot air required for regeneration. The two dehumidification towers operate independently. When the fan air volume is large, more adsorbent is required to absorb water to reach the required dew point. Therefore, a larger dehumidification tower is required to hold molecular sieve. The overall size of the dryer is larger, and more adsorbent also reduces the regeneration efficiency of the dryer. Therefore, a solution is needed to solve the above problems.

### SUMMARY

In order to solve the above problems, the disclosure aims to provide a drying air generator with simple structure and low energy consumption.

In order to achieve the above purpose, the disclosure proposes a drying air generator, which is characterized in that it includes at least two dehumidification towers, which operate parallel. The towers are combined in a dehumidification tower group. One end of the dehumidification tower group is connected with an air outlet control valve. The other end of the dehumidification tower group is connected with at least one regeneration heater. The regeneration heater is connected with a cooler, especially a water cooler. The other end of the cooler is connected with a fan, which is connected with at least one return air filter. A return air control valve is set between the fan and the return air filter.

It is advantageous when a bypass air duct is set between the dehumidification tower group and the air outlet control valve.

The bypass air duct in a preferred embodiment is connected to the regeneration control valve group.

Preferably the regeneration control valve group is connected to the return air control valve via a duct.

In one example, the air outlet control valve is a two-way valve.

In one example, the return air control valve is a three-way valve, which is respectively connectable with the fan, the return air filter and the regeneration control valve group. Through the switch of the return air control valve channels, it matches with the different working states of the drying air generator.

In one example, the regeneration control valve group is composed of two groups of three-way valves in series, which preferably have the same structure.

In a preferred embodiment one end of the one three-way valve is connectable with the other three-way valve.

In an example the return air control valve is connected with the return air control valve through a duct.

Preferably the regeneration control valve group is connected with a pipeline between the dehumidification tower group and the air outlet control valve through the bypass air duct.

In one example, the dehumidification tower group includes two dehumidification towers with the same structure. The ends of the dehumidification towers far from the air outlet control valve are respectively connected with the regeneration heaters.

In one example, the air outlet control valve is connected to the one dehumidification tower and the end of the other dehumidification tower far away from the regeneration heater.

In an example the one regeneration heater and the end of the other regeneration heater far away from the dehumidification tower are connected to the cooler, forming a parallel arrangement.

In one example, the air outlet control valve is connected with an air outlet pipe.

In a simple embodiment the return air filter is connected to a return air pipe.

The disclosed drying air generator can bring the following beneficial effects:
1. The adoption of parallel dehumidification tower structure can effectively reduce the wind resistance, reduce the volume of a single dehumidification tower, and facilitate maintenance.
2. During regeneration, double dehumidifiers are heated simultaneously to improve regeneration efficiency and save energy consumption.
3. It is applicable to discontinuous drying, and the regeneration of adsorbent in the dehumidifier is completed in the drying interval.

### BRIEF DESCRIPTION OF THE DRAWINGS

The attached drawings described here are used to provide a further understanding of the invention. The schematic embodiments and their descriptions of the invention are used to explain the invention, but do not limit the scope of what is claimed. In the attached drawing:

FIG. 1 is the internal structure diagram of a single fan double tower parallel drying air generator.

FIG. 2 is the working principle diagram of the drying state.

FIG. 3 is the working principle diagram of the regenerative heating state.

FIG. 4 is the working principle diagram of the regenerative cooling state.

### DETAILED DESCRIPTION

In order to more clearly explain the overall concept of the invention, the following is detailed by way of example in combination with the drawings of the specification.

In the description of the invention, it needs to be understood that the terms “center”, “top”, “bottom”, “front”, “back”, “left”, “right”, “vertical”, “horizontal”, “top”, “bottom”, “inside”, “outside”, “axial”, “radial”, “circumferential”, etc. indicate the orientation or position relationship based on the orientation or position relationship shown in the drawings. It is only for the convenience of describing the invention and simplifying the description, rather than indicating or implying that the device or element referred to must have a specific orientation, be constructed and operated in a specific orientation, so it cannot be understood as a limitation of the invention.

In addition, the terms “first” and “second” are only used for description purposes and cannot be understood as indicating or implying relative importance or implicitly indicating the number of indicated technical features. Thus, the features defined as “first” and “second” can explicitly or implicitly include one or more of these features. In the description of the invention, “multiple” means two or more, unless otherwise specifically defined.

In the invention, unless otherwise specified and defined, the terms “installation”, “connection”, “connection”, “fixed” and other terms should be understood in a broad sense, for example, they can be fixed connection, removable connection, or integrated. It can be mechanical connection, electrical connection or communication. It can be directly connected or indirectly connected through intermediate media. It can be the internal connection of two components or the interaction between two components. For ordinary technicians in the field, the specific meaning of the above terms in the invention can be understood according to the specific situation.

In the invention, unless otherwise specified and defined, the first feature “above” or “below” the second feature can be the direct contact between the first and second features, or the indirect contact between the first and second features through an intermediate medium. In the description of this specification, reference to the description of the terms “one scheme”, “some schemes”, “example”, “specific example”, or “some examples” means that the specific features, structures, materials or features described in combination with the scheme or examples are included in at least one scheme or example of this invention. In this specification, the schematic expressions of the above terms do not have to refer to the same scheme or example. Moreover, the described specific features, structures, materials or characteristics may be combined in an appropriate manner in any one or more schemes or examples.

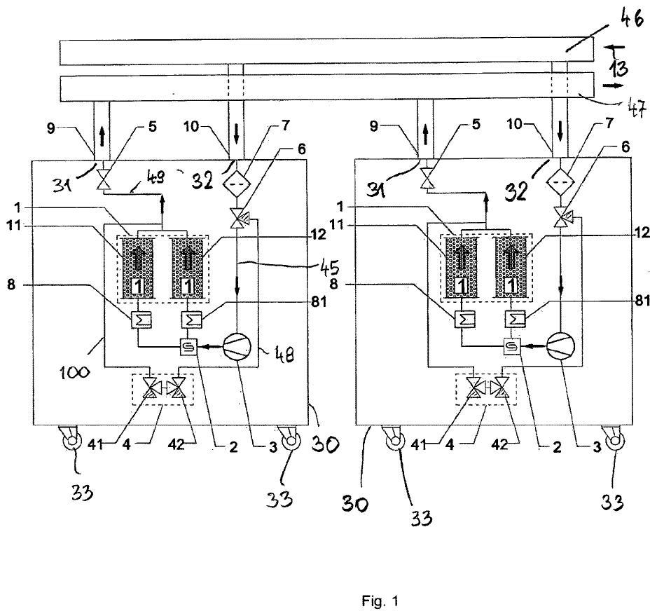

As shown in FIGS. 1 to 4, the embodiment of the invention proposes a single fan double tower parallel drying air generation device, which includes a dehumidification tower group 1, one end of the dehumidification tower group 1 is connected to an air outlet control valve 5, the other end of the dehumidification tower group 1 is connected to a regeneration heater 8, 81 which is positioned between the dehumidification tower group 1 and a water cooler 2. The other end of the water cooler 2 is connected to a fan 3, and the other end of the fan 3 is connected to a return air filter 7. A return air control valve 6 is set between the fan 3 and the return air filter 7. A pipeline 49 is set between the tower group 1 and the air outlet control valve 5. The pipeline 49 is connected to a regeneration control valve group 4 by a bypass air duct 100. The other end of the regeneration control valve group 4 is connected to the return air control valve 6 through a duct 48.

The outlet air control valve 5 is a two-way valve. The return air control valve 6 is a three-way valve, which is respectively connected to the fan 3, to the return air filter 7 and to the regeneration control valve group 4 through the switching of the return air control valve 6 channels.

According to the different working conditions of the drying air generator, the regeneration control valve group 4 can be composed of two sets of three-way valves 41 and 42 with the same structure in series. One end of the three-way valve 42 is connected to the three-way valve 41, the other end is connected to the return air control valve 6 through the duct 48 and the other end of the three-way valve 41 is connected to the pipeline 49 between the dehumidification tower group 1 and the air outlet control valve 5 through the bypass air duct 100.

The dehumidifying tower group 1 includes two dehumidifying towers 11 and 12 with the same structure. One end of the dehumidifying towers 11 and 12 far from the air outlet control valve 5 is respectively connected with the regeneration heater 8 and the regeneration heater 81. The ends of the dehumidifying towers 11, 12 far from the regeneration heaters 8, 81 are connected with the air outlet control valve 5. The other end of the regeneration heaters 8, 81 far from the dehumidifying towers 11, 12 is connected with the water cooler 2, forming a parallel arrangement. The other end of the air outlet control valve 5 is extended to an air outlet pipe 9, and the other end of the air return filter 7 is connected to an air return pipe 10.

FIG. 1 shows an embodiment with two drying air generators, which have the same structure. The air outlet pipes 9 are connected to a common air outlet conduct 47, while the air return pipes 10 of the drying air generators are connected to a common air return duct 46.

The drying air generators each have a housing 30 in which the described parts are housed. On the top of the housings 30 advantageously are provided connections 31, 32, e.g., couplings, for the air outlet and air inlet pipes 9, 10.

The housing 30 is advantageously movable. Wheels 33 are provided on the underside of the housing 30, with help of which the housing 30 and thus drying air generator can easily be moved.

### Working Principle

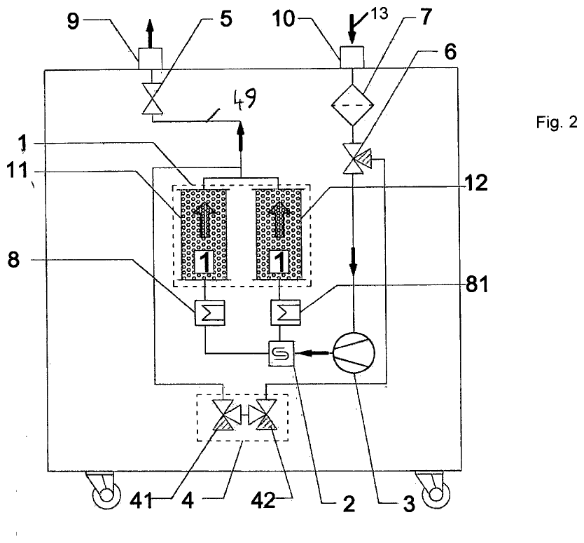

When the drying air generator is in the drying process (FIG. 2), the air outlet control valve 5 is switched to be connected with the air outlet pipeline 9. The return air control valve 6 is so switched that it is connected with the return air filter 7. The return air 13 flows under an air outlet management through the return air filter 7 and the return air control valve 6 to the fan 3. The return air 13 then passes the cooler 2, the regeneration heaters 8, 81 and the dehumidification towers 11, 12.

In the dehumidification towers 11, 12 the return air 13 is dehumidified in a known manner. The return air 13 then flows via the pipeline 49 and the air outlet control valve 5 into the air outlet pipe 9. The air flow path is indicated by arrows in FIG. 2.

At this time, the regeneration heaters 8, 81 do not work. The regeneration control valve group 4 is so switched, that the internal air flow is isolated from the external air.

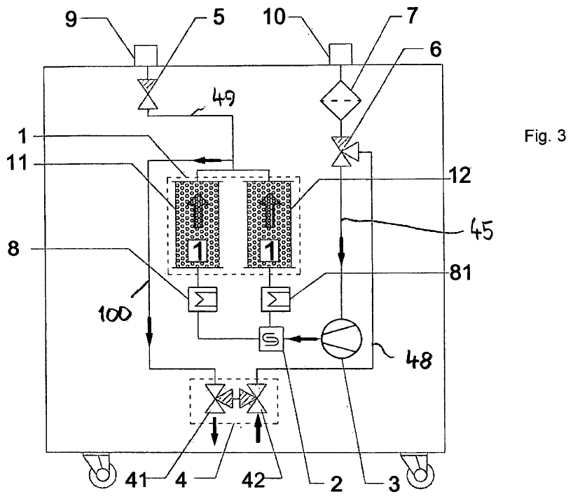

When the regeneration is in the heating stage (FIG. 3), the outlet air control valve 5 is closed. The return air control valve 6 is switched to connect with the regeneration control valve group 4. The regeneration control valve group 4 is switched to connect the bypass air duct 100 with the outside atmosphere.

In FIG. 3 the air flow path is indicated by arrows. The regenerating air flows from the return air control valve 6 through the conduct 45 to the fan 3, which conveys the regenerating air via the water cooler 2 to the regeneration heaters 8, 81, which are connected to the water cooler 2. The regeneration heaters 8, 81 are turned on, while the water cooler 2 is switched off. The regeneration heaters 8, 82 heat the regenerating air before it enters the dehumidification towers 11, 12. From here regenerating air enters the bypass air duct 100, in which the air flows to the three-way valve 41, which is so switched that the air is discharged into the atmosphere.

The other three-way valve 42 is so switched that the fan 3 can suck in the air from the atmosphere. The sucked in air flows through the duct 48 to the return air control valve 6, which is so switched that the regenerating air can flow into the conduct 45 and to the fan 3. Both three-way valves 41, 42 of the regeneration control valve group 4 air so switched, that they are not connected to each other.

The valves 5, 6 in this heating stage prevent that the regenerating air can enter the air outlet pipe 9 or that air can enter the drying air generator via the return pipe 10 and the return air filter 7.

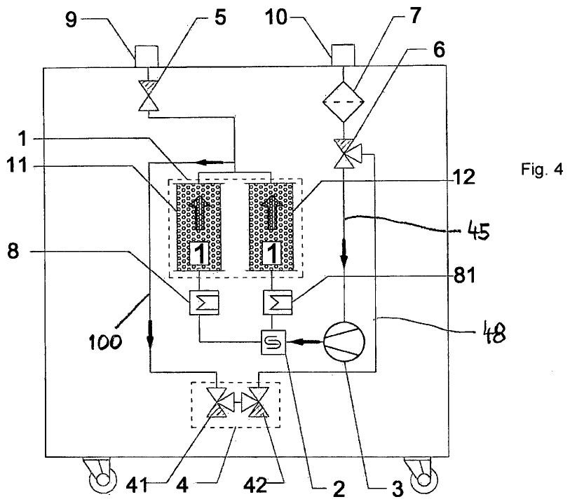

When the regeneration is in the cooling stage (FIG. 4), the regeneration control valves 41, 42 are switched to isolate the internal pipelines from the external atmosphere. The regeneration air is circulated inside the drying air generator (see arrows in FIG. 4). The fan 3 conveys the air to the water cooler 2, which is switched on for cooling the air. The regeneration heaters 8, 81 are shut up so that the air is not heated. The cooled air flows through the dehumidifying towers 11, 12 and cools the adsorbent in the dehumidifying towers 11, 12. The air leaves the towers 11, 12 and enters the bypass air duct 100. The air outlet control valve 5 is closed so that air cannot enter the air outlet pipe 9.

In the bypass air duct 100 the air flows to the regeneration control valve group 4, the valves 41, 42 of which are so switched, that they are connected to each other. The air therefore can enter the duct 48, which connects the regeneration control valve group 4 with the return air control valve 6. It is so switched, that it closes the access to the air return pipe 10. The air enters the conduct 45 in which the air flows to the fan 3.

The descripted valves preferably operated by a (not shown) control.

The invention generator has a simple construction. Only one fan 3 is required for the operating of the generator.

Each embodiment in this specification is described in a progressive manner. The same and similar parts of each embodiment can be referred to each other. Each embodiment focuses on the differences with other embodiments. In particular, for the system embodiment, since it is basically similar to the method embodiment, the description is relatively simple. Please refer to the partial description of the method embodiment for details.

The above is only an embodiment of the invention and is not used to limit the invention. For those skilled in the art, the invention can have various changes. Any modification, equivalent replacement, improvement, etc. made within the spirit and principle of the invention shall be included in the claims of the invention.

1-19. (canceled)

20. A dry air generator for plastics, comprising:
at least two towers (11, 12) in parallel operation, the at least two towers (11, 12) being combined in a dehumidification tower group (1);
an air outlet control valve (5) connected to one end of the dehumidification tower group (1);
an air outlet pipeline (9) connected to the air outlet control valve (5);
a regeneration heater (8, 81) connected to the dehumidification tower group (1);
a cooler (2);
a fan (3) connected to the cooler (2);
a return air filter (7) connected with the fan (3);
a return air pipeline (10) connected to the return air filter (7); and
a return air control valve (6) positioned between the fan (3) and the return air filter (7),
wherein the regenerator heater (8, 81) is connected with the cooler (2) and is positioned at an end of the dehumidification tower group (1) opposite the air outlet control valve (5).

21. The dry air generator according to claim 20, further comprising
a bypass air duct (100) arranged between the dehumidification tower group (1) and the air outlet control valve (5).

22. The dry air generator according to claim 21,
wherein the bypass air duct (100) is connected to a regeneration control valve group (4).

23. The dry air generator according to claim 22,
wherein the regeneration control valve group (4) is connected to the return air control valve (6) via a duct (48).

24. The dry air generator according to claim 20,
wherein the air outlet control valve (5) is a two-way valve.

25. The dry air generator according to claim 22,
wherein the return air control valve (6) is a three-way valve, the three-way valve being connected with the fan (3), the return air filter (7), and the regeneration control valve group (4).

26. The dry air generator according to claim 22,
wherein the regeneration control valve group (4) is composed of two three-way valves (41, 42) in series.

27. The dry air generator according to claim 26,
wherein one end of a first of the two three-way valves (41) is connected with a second of the two three-way valves (42).

28. The dry air generator according to claim 22,
wherein the regeneration control valve group (4) is connected with the return air control valve (6) through a duct (48).

29. The dry air generator according to claim 22,
wherein the regeneration control valve group (4) is connected to a pipeline (49) between the dehumidification tower group (1) and the air outlet control valve (5) through the bypass air duct (100).
